(19) United States
(12) Patent Application Publication
(10) Pub. No.: US 2017/0072543 A1
(43) Pub. Date: Mar. 16, 2017

(54) Ratchet Wrench Extension

(71) Applicant: Randy Taylor, Whitehorse (CA)

(72) Inventor: Randy Taylor, Whitehorse (CA)

(21) Appl. No.: 14/851,410

(22) Filed: Sep. 11, 2015

(51) Int. Cl. B25B 13/48; B25B 23/12; B25B 13/46; B25G 1/04; B25G 1/00

(52) U.S. Cl. CPC B25B 13/481; B25G 1/043; B25G 1/005; B25B 13/46; B25B 23/12

(57) ABSTRACT

The present invention discloses a ratchet wrench consisting of socket head at one end, an extended arm in the middle and a pivoting extension arm having an extended handle grip at the opposite end. The socket wrench is designed in a manner to install and tighten nuts onto machine bolts and break loose and remove nuts wherein the nuts are in a confined or recessed area making it difficult to reach with conventional ratchet wrench extension mechanisms.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of the Invention

The present invention relates to the field of the wrench extension mechanism and more particularly, the invention relates to a socket wrench extension which is adapted to positively reach at the difficult places as well.

(2) Background of the Invention

As is well known, a wrench is a hand tool used for holding and turning elements such as nuts, pipes, spark plugs, and the like. There are many kinds of wrenches, including monkey wrenches, single-ended wrenches, double-ended wrenches, box wrenches, and the like. Two common wrenches are the socket wrench which combines an offset handle with a male drive piece having a spring-loaded bearing lock on various sized sockets, and a ratchet wrench which is a socket wrench having a ratchet mechanism which controls the direction of applied torque.

Socket wrenches have become widely used in virtually every industry in the country. In its simplest form a socket wrench is an elongated device, commonly referred to as a drive, having one end adapted to receive a socket. Since the inception of the socket wrench, there have been a number of changes and improvements on this main idea.

Various prior arts have disclosed improved socket wrenches with ratcheting mechanism likewise; Patent No US 20130098212 A1 discloses telescopic extension device for a handle of a wrench includes three sliding overlapping concentric tubular members. A mechanism is for retaining the three tubular members in an extended position. When the three tubular members are in the extended position, the handle of the wrench will snugly fit into a front end of the first tubular member having the smallest diameter, so as to help increase the amount of torque applied by a person using the wrench to either loosen or tighten a nut and bolt.

Similarly, prior art, U.S. Pat. No. 5,832,794 A discloses an extension handle apparatus for wrenches comprising an extension bar, a fixed support bracket fixedly coupled to the extension bar, and a moveable support bracket slide-ably coupled to the extension bar. The moveable support bracket comprises a sliding jacket member, first and second spring retaining protrusions and a locking spring wherein the moveable support bracket is moved along the length of a portion of the extension bar for accommodating a variety of wrench lengths.

Another prior art, U.S. Pat. No. 6,053,076 A is an improved ratchet wrench with a handle pivotally attached to a rotating head which can be locked into a position either axially aligned with the handle or laterally angled to one side of the handle. A locking mechanism includes a spring-biased, J-shaped structure, having an actuating shaft which passes through the handle and a locking pin which selectively engages one of a plurality of holes defined in a neck of the rotating head. Angling the handle to one side allows the wrench to be used to loosen or tighten bolts where there is insufficient space to use a conventional straight wrench. The ratchet head may also be removed from the handle for use as a palm wrench or for substitution of the ratchet head with a ratchet head of a different size.

A socket wrench extension is also disclosed in prior art, U.S. Pat. No. 4,502,365 A wherein a socket wrench extension for effecting a quick release and simultaneous removal of socket is disclosed. The invention discloses socket wrenches and more particularly a socket wrench extension which is adapted to positively lock sockets in place on the extension.

A distributor ratchet wrench attached to an offset vertically elongated handle with the control for operating the ratchet on the upper extremity of the handle. This wrench finds important use in loosening and tightening the clamp nut of a distributor when adjusting the timing on an internal combustion engine as disclosed in a prior art, U.S. Pat. No. 4,276,791 A.

Likewise, many other prior arts, U.S. Pat. No. 6,112,625 A; U.S. Pat. No. 6,138,533 A; U.S. Pat. No. 4,546,678 A; US 20060156870 A1; U.S. Pat. No. 7,188,553 B1; U.S. Pat. No. 5,033,337 A; U.S. Pat. No. 2,600,177 A; U.S. Pat. No. 6,286,396 B1; U.S. Pat. No. 5,911,798 A; U.S. Pat. No. 5,067,376 A and U.S. Pat. No. 4,905,548 A discloses various methods and apparatus for ratchet wrench extension devices.

Numerous tool devices have been provided in the prior art that are adapted to extend wrenches. While these units may be suitable for the particular purpose to which they address, they would not be as suitable for the purpose of the present invention as hereafter described.

### SUMMARY

In view of the foregoing applications inherent in the known types of ratchet wrench extensions present in the prior art, the present invention provides an improved socket wrench with ratcheting mechanism wherein the socket wrench is provided with an extension at one end to reach at difficult areas or tight spaces with ease and convenience. As such, the general purpose of the present invention, which will be described subsequently in greater detail, is to provide an improved ratchet wrench extension which has all the advantages of the prior art and none of the disadvantages.

Accordingly, it is an object of the present invention to provide an adjustable socket wrench extension that will overcome all the shortcomings mentioned in the prior art. It is also provides a convenient, easy to use rotating head ratchet wrench to allow the user to reach bolts where insufficient space exists to use a conventional straight handled wrench. Further, the present invention provides a locking mechanism for the rotating head which will not unlock from its position once the wrench is set.

The present invention further avoids the rotating of the whole tool like a ratchet or wrench instead the socket end takes the ratchet or wrench out of tight areas and can rotate freely. A magnetic piece is also provided in the side wall of the wrench part that will hold the nut or bolt, wherein the same would suck the nut or bolt to fall down at the desired place.

According to the invention, provided is a means for retaining the tubular member in an extended position, the handle of the wrench will snugly fit into a front end of said tubular member to help increase the amount of torque applied by a person using said wrench to either loosen and tighten a nut and bolt

One object of the present invention is to provide an extension wherein the socket could be released and removed easily and which is also easy to hold in place while it is being rotated.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates a prospective view of the invention with its components.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention.

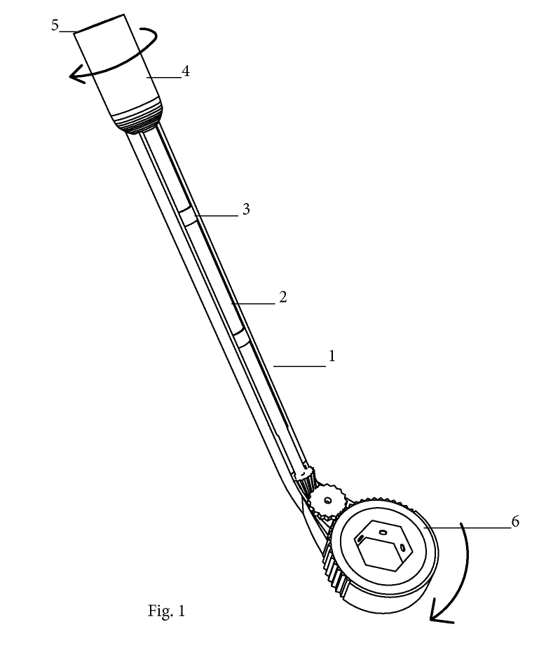

With reference to the drawings, specifically to FIG. 1 shows a telescopic extension device for a handle 1 of a wrench, an extendable tubular arm member 2 like a bar, with a housing to hold a socket 3 with a gear assembly 4 to turn said wrench at one end and a rotating handle at other end.

The present invention discloses a socket wrench extension device ratcheting mechanism that includes an extended tubular bar member, bushing 5 provided for rotatory movement, gripping handle attached to a knob to loosen and fasten the extension. The extended bar is connected to socket wrench at the opposite end. The socket wrench provided includes a female fastening member 6 that will fasten over the male counterpart to tighten the bolt in one direction.

In its preferred embodiment, the present invention is an improved socket wrench extension with a housing that holds the socket extended spline gear; another gear to help the closed wrench gear turn the same way as the socket; gear covering cover; retaining ring to hold the end of socket; handle pivotally attached to rotating head which can be locked in a certain position. Angling the handle to one side allows the wrench to be used to loosen or tighten bolts where there is insufficient space to use a conventional straight wrench.

Briefly described; the present invention is a socket wrench extension having an extended arm, an attachment located at one of the arm to connect to the drive of the socket wrench, a receiving member located on the other end. A control means mounted over the arm wherein the control means operates to either release or positively lock the socket onto the receiving member.

The present invention further avoids the rotating of the whole tool like a ratchet or wrench instead the socket end takes the ratchet or wrench out of tight areas and can rotate freely. A magnetic piece is also provided in the side wall of the wrench part that will hold the nut or bolt, wherein the same would suck the nut or bolt to fall down at the desired place.

According to the invention, provided is a means for retaining the tubular member in an extended position, the handle of the wrench will snugly fit into a front end of said tubular member to help increase the amount of torque applied by a person using said wrench to either loosen and tighten a nut and bolt.

Further according to the invention the extendable tubular arm member further comprises of bushing to make rotation and is made of strong durable material like stainless steel.

While a preferred embodiment of the present invention has been shown and described, it will be apparent to those skilled in the art that many changes and modifications may be made without departing from the invention in its broader aspects.

I claim:

1. A telescopic extension device for a handle of a wrench which comprises:
an extendable tubular arm member with a housing to hold a socket with a gear assembly to turn said wrench at one end and a rotating handle at other end; and
a means for retaining said tubular members in an extended position, said handle of the wrench will snugly fit into a front end of said tubular member to help increase the amount of torque applied by a person using said wrench to either loosen and tighten a nut and bolt.

2. The telescopic extension device for a handle of a wrench set forth in claim 1, wherein said extendable arm further comprises of bushing to make rotation.

3. The telescopic extension device for a handle of a wrench set forth in claim 1, wherein said gear assembly further comprises of a gear cover.

4. The telescopic extension device for a handle of a wrench set forth in claim 1, wherein said three tubular members are comprised out of a strong durable material.

5. The telescopic extension device for a handle of a wrench set forth in claim 4, wherein said strong durable material is stainless steel.

6. The telescopic extension device for a handle of a wrench set forth in claim 1, wherein the gears turns said wrench at end of said extension allowing it to fit properly.

7. The telescopic extension device for a handle of a wrench set forth in claim 1, wherein said wrench is a ratchet wrench. The telescopic extension device for a handle of a wrench set forth in claim 1, wherein said gear assembly comprises of a rack-and-pinion arrangement.

8. The telescopic extension device for a handle of a wrench set forth in claim 1, wherein device enables tightening of said nut and bolt in tight spaces.

9. The telescopic extension device for a handle of a wrench set forth in claim 1, wherein said wrench has magnetic mechanism to hold said nut and said bolt.

10. The telescopic extension device for a handle of a wrench set forth in claim 9, wherein said wrench has magnetic mechanism to hold said nut and bolt is a magnet.
